(19) United States
(12) Patent Application Publication
(10) Pub. No.: US 2026/0333191 A1
(43) Pub. Date: Oct. 22, 2026

(54) USER-FRIENDLY CELLULAR-BACKUP FOR RESIDENTIAL GATEWAY LEVERAGING A MOBILE-DEVICE

(71) Applicant: Thomson Licensing, Cesson-Sevigne (FR)

(72) Inventors: Jay STRATER, San Diego, CA (US); Gregory NAKANISHI, San Diego, CA (US); Richard MOORE, JR., Harleysville, PA (US)

(21) Appl. No.: 18/874,250

(22) PCT Filed: Jun. 1, 2023
(86) PCT No.: PCT/US2023/024111

§ 371 Date: Dec. 12, 2024

Related U.S. Application Data
(60) Provisional application No. 63/354,808, filed on Jun. 23, 2022.

(51) Int. Cl. H04W 40/28; H04W 24/04; H04W 88/16

(52) U.S. Cl. CPC H04W 40/28; H04W 24/04; H04W 88/16

(57) ABSTRACT

A gateway device for use with a wide area network, wireless wide area network, a local area network, a client device, a wireless device, said gateway device including a memory; a primary communication system; a wireless communication system; and a processor configured to execute instructions stored on the memory to cause the gateway device to: receive the hotspot ID and hotspot credentials from the wireless device; instruct the primary communication system to route the client device data between the client device and the wide area network and to route the wireless device data between the wireless device and the wide area network; detect a loss of connection with the wide area network; and instruct the wireless communication system to route the client device data between the client device and the wide area network via the wireless device and the wireless wide area network.

### BACKGROUND

Embodiments of the invention relate to using a hotspot device.

### SUMMARY

Aspects of the present invention are drawn to a gateway device for use with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device, being configured to operate in a hotspot mode so as to wirelessly transmit the wireless device data and the client device data to the wide area network via the wireless wide area network, and being configured to transmit a hotspot ID and hotspot credentials to the gateway device, the gateway device including: a memory; a primary communication system configured to route the client device data between the client device and the wide area network and to route the wireless device data between the wireless device and the wide area network; a wireless communication system configured to route the client device data between the client device and the wide area network via the wireless device and the wireless wide area network; and a processor configured to execute instructions stored on the memory to cause the gateway device to: receive the hotspot ID and hotspot credentials from the wireless device; instruct the primary communication system to route the client device data between the client device and the wide area network and to route the wireless device data between the wireless device and the wide area network; detect a loss of connection with the wide area network; and instruct the wireless communication system to route the client device data between the client device and the wide area network via the wireless device and the wireless wide area network.

In some embodiments, the processor is configured to execute instructions stored on the memory to additionally cause the gateway device to establish constraints in the hotspot mode.

In some of these embodiments, the gateway device, wherein the constraints are selected from a group of constraints consisting of a time limit of the hotspot mode, a traffic rate limit in the hotspot mode, a data type in the hotspot mode, and combinations thereof.

In some of these embodiments, the gateway device, wherein the primary communication system is configured to route the client device data between the client device and the wide area network via an interface system selected from a group of interface systems consisting of a data over a cable service interface specification system, a passive optical network system, an Ethernet system, and a digital subscriber line system.

In some embodiments, the processor is configured to execute instructions stored on the memory to additionally cause the gateway device to request the hotspot ID and hotspot credentials from the wireless device.

In some embodiments, the gateway device, wherein the primary communication system includes a wireless communication system.

Other aspects of the present disclosure are drawn to a method of using a gateway device with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device, being configured to operate in a hotspot mode so as to wirelessly transmit the wireless device data and the client device data to the wide area network via the wireless wide area network, and being configured to transmit a hotspot ID and hotspot credentials to the gateway device, the method including: receiving, via a processor configured to execute instructions stored on a memory, the hotspot ID and hotspot credentials from the wireless device; instructing, via the processor, a primary communication system to route the client device data between the client device and the wide area network and to route the wireless device data between the wireless device and the wide area network; detecting, via the processor, a loss of connection with the wide area network; and instructing, via the processor, a wireless communication system to route the client device data between the client device and the wide area network via the wireless device and the wireless wide area network.

In some embodiments, the method, wherein the instructing, via the processor, the wireless communication system to route the client device data between the client device and the wide area network via the wireless device and the wireless wide area network includes establishing constraints in the hotspot mode.

In some of these embodiments, the method, wherein the establishing constraints in the hotspot mode includes establishing the constraints as selected from a group of constraints consisting of a time limit of the hotspot mode, a traffic rate limit in the hotspot mode, a data type in the hotspot mode, and combinations thereof.

In some of these embodiments, the method, wherein the instructing, via the processor configured to execute instructions stored on a memory, the primary communication system to route the client device data between the client device and the wide area network and to route the wireless device data between the wireless device and the wide area network includes instructing the primary communication system to route the client device data between the client device and the wide area network and to route the wireless device data between the wireless device and the wide area network via an interface system selected from a group of interface systems consisting of a data over a cable service interface specification system, a passive optical network system, an Ethernet system, and a digital subscriber line system.

In some embodiments, the method further includes instructing, via the processor, a primary communication system to request the hotspot ID and hotspot credentials from the wireless device.

In some embodiments, the method, wherein the instructing, via the processor configured to execute instructions stored on a memory, the primary communication system to route the client device data between the client device and the wide area network and to route the wireless device data between the wireless device and the wide area network additionally includes instructing a wireless communication system to route the client device data between the client device and the wide area network and to route the wireless device data between the wireless device and the wide area network.

Other aspects of the present disclosure are drawn to a non-transitory, computer-readable media having computer-readable instructions stored thereon, the computer-readable instructions being capable of being read by a gateway device for use with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device, being configured to operate in a hotspot mode so as to wirelessly transmit the wireless device data and the client device data to the wide area network via the wireless wide area network, and being configured to transmit a hotspot ID and hotspot credentials to the gateway device, wherein the computer-readable instructions are capable of instructing the client device to perform the method including: receiving, via a processor configured to execute instructions stored on a memory, the hotspot ID and hotspot credentials from the wireless device; instructing, via the processor, a primary communication system to route the client device data between the client device and the wide area network and to route the wireless device data between the wireless device and the wide area network; detecting, via the processor, a loss of connection with the wide area network; and instructing, via the processor, a wireless communication system to route the client device data between the client device and the wide area network via the wireless device and the wireless wide area network.

In some embodiments, the non-transitory, computer-readable media, wherein the computer-readable instructions are capable of instructing the client device to perform the method wherein the instructing, via the processor, the wireless communication system to route the client device data between the client device and the wide area network via the wireless device and the wireless wide area network includes establishing constraints in the hotspot mode.

In some of these embodiments, the non-transitory, computer-readable media, wherein the computer-readable instructions are capable of instructing the client device to perform the method wherein the establishing constraints in the hotspot mode includes establishing the constraints as selected from a group of constraints consisting of a time limit of the hotspot mode, a traffic rate limit in the hotspot mode, a data type in the hotspot mode, and combinations thereof.

In some of these embodiments, the non-transitory, computer-readable media, wherein the computer-readable instructions are capable of instructing the client device to perform the method wherein the instructing, via the processor configured to execute instructions stored on a memory, the primary communication system to route the client device data between the client device and the wide area network and to route the wireless device data between the wireless device and the wide area network includes instructing the primary communication system to route the client device data between the client device and the wide area network and to route the wireless device data between the wireless device and the wide area network via an interface system selected from a group of interface systems consisting of a data over a cable service interface specification system, a passive optical network system, an Ethernet system, and a digital subscriber line system.

In some further embodiments, the non-transitory, computer-readable media of claim 15, wherein the computer-readable instructions are capable of instructing the client device to perform the method further including instructing, via the processor, a primary communication system to request the hotspot ID and hotspot credentials from the wireless device.

In some embodiments, the non-transitory, computer-readable media, wherein the computer-readable instructions are capable of instructing the client device to perform the method wherein the instructing, via the processor configured to execute instructions stored on a memory, the primary communication system to route the client device data between the client device and the wide area network and to route the wireless device data between the wireless device and the wide area network additionally includes instructing a wireless communication system to route the client device data between the client device and the wide area network and to route the wireless device data between the wireless device and the wide area network.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1A illustrates a communication system at a time t₀;

FIG. 1B illustrates a communication system at a time t₁;

FIG. 2A illustrates a ladder chart for connecting to a wide area network (WAN) through a hotspot in accordance with aspects of the present disclosure;

FIG. 2B illustrates a continuation of the ladder chart for connecting to a WAN through a hotspot in accordance with aspects of the present disclosure;

FIG. 3A illustrates a communication system at a time t₀ in accordance with aspects of the present disclosure;

FIG. 3B illustrates a communication system at a time t₁ in accordance with aspects of the present disclosure;

FIG. 3C illustrates a communication system at a time t₂ in accordance with aspects of the present disclosure;

FIG. 3D illustrates a communication system at a time t₃ in accordance with aspects of the present disclosure; and

FIG. 4 illustrates an exploded view of a hotspot client device, a client device, and a gateway device.

### DETAILED DESCRIPTION

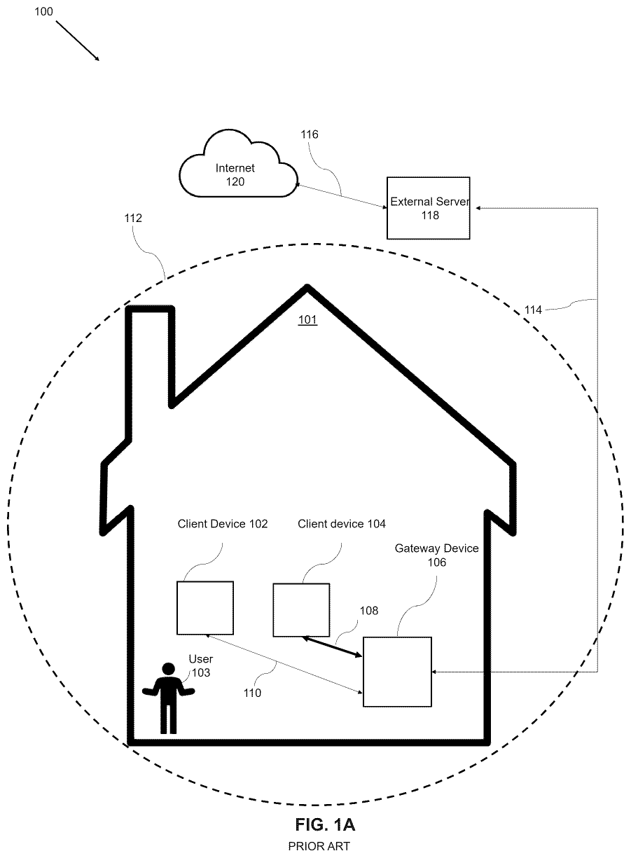

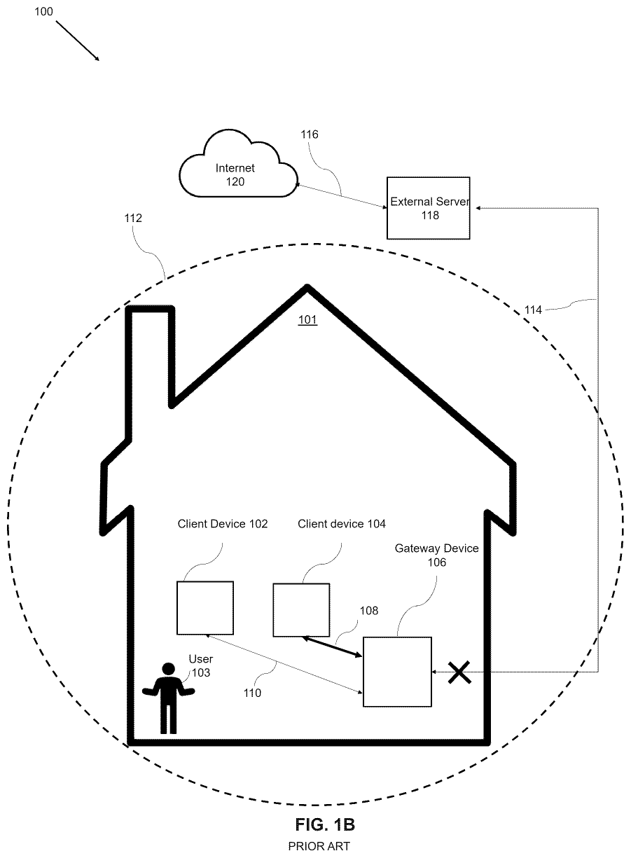

FIG. 1A illustrates a communication system 100 at a time to.

As shown in FIG. 1A, communication system 100 includes: a residence 101; client devices 102 and 104; a user 103; a gateway device (GD) 106; a wired communication channel 108; a wireless communication channel 110, a Wide Area Network (WAN) communication link 114, a communication link 116; a local area network (LAN) 112; an external server 118; and an Internet 120.

Client devices 102 and 104 may be any devices or systems that present content to, accept inputs from, or directly or indirectly interact with user 103. In this non-limiting example, client devices 102 and 104 may be smart phones, tablets, personal computers, TV set-top boxes, videogame consoles, smart media devices, home security devices, or Internet-of-Things (IoT) devices.

GD 106 is a device that combines the functions of a modem and a router. A modem is a device that connects to cable or phone lines and translates the data or information from the Internet to a computer or connected device. A router is a device that works with the modem to create and manage a wireless network so as to wirelessly take the data coming through the modem and sends it wirelessly to multiple devices like smart phones, tablets, gaming consoles, and computers. The consumer premises can include a residential dwelling, an office, or any other business space of a user, such as residence 101. The terms home, office, and premises may be used synonymously herein.

GD 106 may perform such functions as Web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Further, it should be noted that GD 106 is able to communicate with external server 118 via WAN communication link 114, which may optionally be a wireless communication system, such as 4G, or 5G, or may optionally be any known type of wired communication channels, non-limiting examples of which include ethernet, DSL, and Fiber. GD 106 is further able to connect to Internet 120 via communication link 116, which may optionally be a wireless communication system, such as 4G, or 5G, or may optionally be any known type of wired communication channels, non-limiting examples of which include ethernet, DSL, and Fiber.

GD 106 serves as a gateway or access point to Internet 120 for one or more electronic devices.

A wireless access point (WAP), or more generally known as an access point (AP), is a networking hardware device that allows other Wi-Fi devices to connect to a Wi-Fi network. A service set ID (SSID) is an identification (in IEEE 802.11) that is broadcast by access points in beacon packets to announce the presence of a network access point for the SSID. SSIDs are customizable IDs that can be zero to 32 bytes, and can be in a natural language, such as English. In residence 101, GD 106 is an access point.

Client device 102 is wirelessly connected to GD 106. Client device 104 is physically connected to GD 106, e.g., through an Ethernet interface.

LAN 112 is created and managed through GD 106. LAN 112 is illustrated as a single network, merely for purposes of discussion. It should be noted that LAN 112 may represent a plurality of local area networks created and managed through GD 106. LAN 112 is a communication network where client device 102 can wirelessly communicate with GD 106 in order to access Internet 120 through WAN communication link 114, external server 118, and communication link 116. Client device 104 is connected to LAN 112 through wired communication channel 108. As such, for purposes of this discussion, LAN 112 includes a wireless network for client device 102 to wireless communicate with GD 106 and a wired network, e.g., an Ethernet interface, for client device 104 to communicate with GD 106.

FIG. 1B illustrates communication system 100 at a time t₁.

As shown in FIG. 1B, WAN communication link 114 has been disconnected. GD 106 no longer has access to Internet 120. Non-limiting examples of reasons for GD 106 being disconnected from Internet 120 include: inclement weather; a WAN communication link being cut; or connectivity issues with the wired or wireless communication functions of GD 106.

In instances where the GD is disconnected from the WAN, it can be inconvenient to users operating network devices. In particular, client device 104 may still communicate with GD 106 via wired communication channel 108 and client device 102 may communicate with GD 106 via wireless communication channel 110. However, if either of client device 104 or client device 102 are attempting to access Internet 120 via GD 106, in instances where the communication between GD 106 and Internet 120 are down, client device 104 and client device 102 will also be unable to access Internet 120. While these instances may be few and far between, some will be more inconvenient than others due to the length of time that the GD is disconnected from the Internet. There needs to be a way for users to minimize time without Internet access while the GD attempts to reconnect to the network.

What is needed is a system and method for alternately connecting to the external WAN in instance where the communication between a GD and an external WAN is temporarily down.

A system and method in accordance with the present disclosure connects to a WAN through the use of a WiFi hotspot.

In accordance with the present disclosure, a GD is used with a hotspot client device (HCD). The HCD will connect to the network associated with the GD. The GD and HCD will communicate with one another through the use of primary radios. In the case of the GD disconnecting from a WAN, a user, who previously configured the HCD to act as a hotspot in such a circumstance, will use the HCD to act as a hotspot by connecting to the WAN cellularly. In this case, the GD will 1) request the HCD to establish the WiFi hotspot (using the WiFi credentials known between HCD and GD) and 2) enable a backhaul STA (bSTA) to connect to the hotspot, and 3) disable any unwanted fronthaul BSS (fBSS) services such as a GD WiFi hotspot service. For purposes of discussion only, let the WAN be the Internet in example embodiments disclosed herein. As such, it should be noted that in a broader sense, a GD in accordance with aspects of the present disclosure may additionally be used with any WAN.

The GD will connect to the HCD, and thereby be connected to the Internet through the HCD. The HCD will temporarily provide Internet access to all devices connected to the GD.

Once the GD is again able to connect to the Internet, the GD will 1) request the HCD to disable its WiFi hotspot 2) disconnect its bSTA from the HCD, and 3) enable any previously disabled fronthaul BSS (fBSS) services such as a GD WiFi hotspot service. The HCD will stop acting as a hotspot and reconnect to the GD as a client. In this way, all the client devices will still have access to the Internet when the direct communication between the GD and the Internet is disrupted.

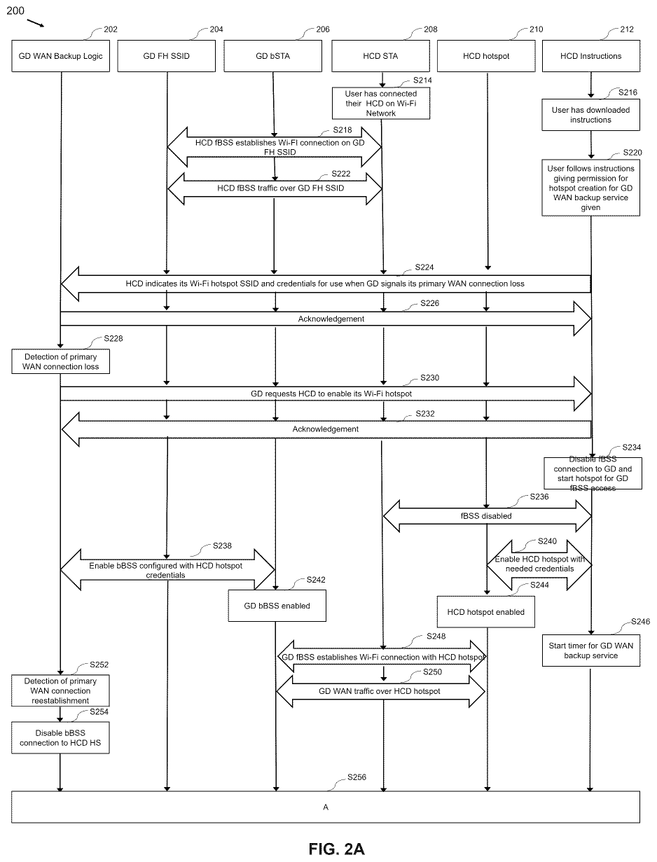

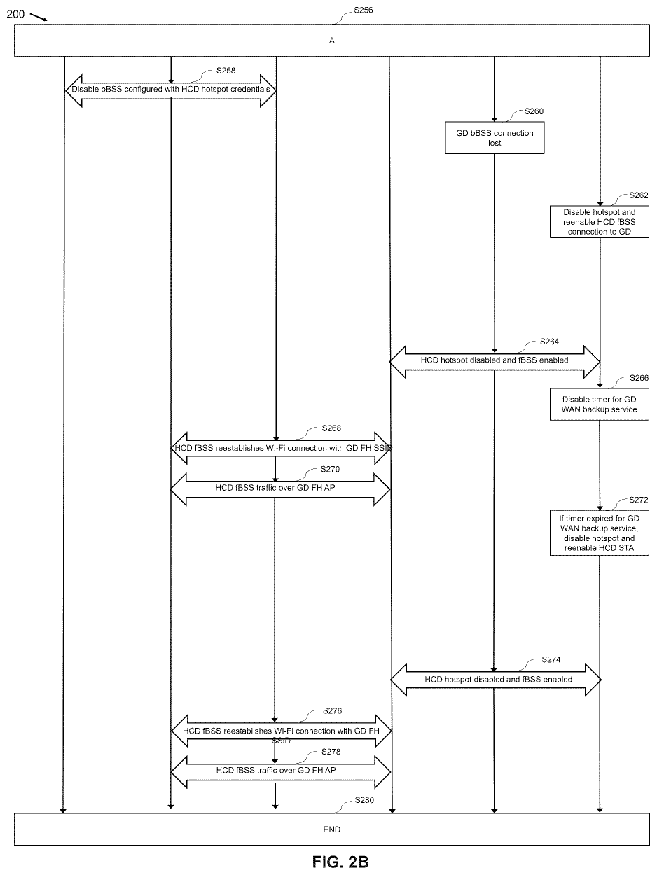

An example system and method for connecting to a WAN through the use of a hotspot in accordance with aspects of the present disclosure will now be described in greater detail with reference to FIGS. 2A-4.

FIG. 2A illustrates a ladder chart 200 for connecting to a WAN through a hotspot in accordance with aspects of the present disclosure.

Ladder chart 200 includes six columns: gateway device (GD) WAN backup logic 202; GD fronthaul (FH) SSID 204; GD backhaul STA (bSTA) 206; hotspot client device (HCD) STA 208; HCD hotspot 210 (using a fronthaul BSS service for the GD bSTA); and HCD instructions 212.

GD WAN backup logic (202) encompasses the connection status of the GD. The GD has two modes of operation: a primary mode and a hotspot mode. During the primary mode of operation, the GD provides Internet access to all connected devices. During the hotspot mode of operation, the GD connects to the HCD as a client. The GD will have access to the Internet via the HCD. All devices connected to the GD during the primary mode of operation will have access to the Internet by remaining connected to the GD.

GD FH SSID (204) encompasses primary mode of operation functions for the GD.

During the primary mode of operation, client devices will establish Wi-Fi connections on the fronthaul SSID of the GD.

GD bSTA (206) encompasses hotspot mode of operation functions for the GD. During the hotspot mode of operation, the GD will connect to a hotspot device which will provide Internet access to the GD. Client devices connected to the GD will access the Internet through the HCD.

HCD STA (208) encompasses primary mode of operation functions for the HCD. During the primary mode of operation, the HCD will connect to the GD as a regular client device.

HCD hotspot (210) encompasses hotspot mode of operation functions for the HCD. During the hotspot mode of operation, the HCD will begin operating as a hotspot. The GD will connect to the hotspot in order to gain access to the Internet. Once the GD is able to reconnect to the Internet through the original communication channel, the HCD will stop operating as a hotspot and reconnect to the GD as a client. In some embodiments, the HCD will activate a timer, where the HCD will act as a hotspot until the timer times out.

HCD instructions (212) encompasses instructions for the HCD. The HCD has two modes of operation: a primary mode and a hotspot mode. During the primary mode of operation, the HCD will connect to the GD as a regular client device. During the hotspot mode of operation, the HCD will disconnect from the GD and act as a hotspot. The HCD will connect to a cellular network and, in turn, connect to the Internet via the cellular communication channel. The GD, having previously received the hotspot credentials, will connect to the HCD. The HCD will provide Internet access to the GD, which in turn provides Internet access to all connected devices.

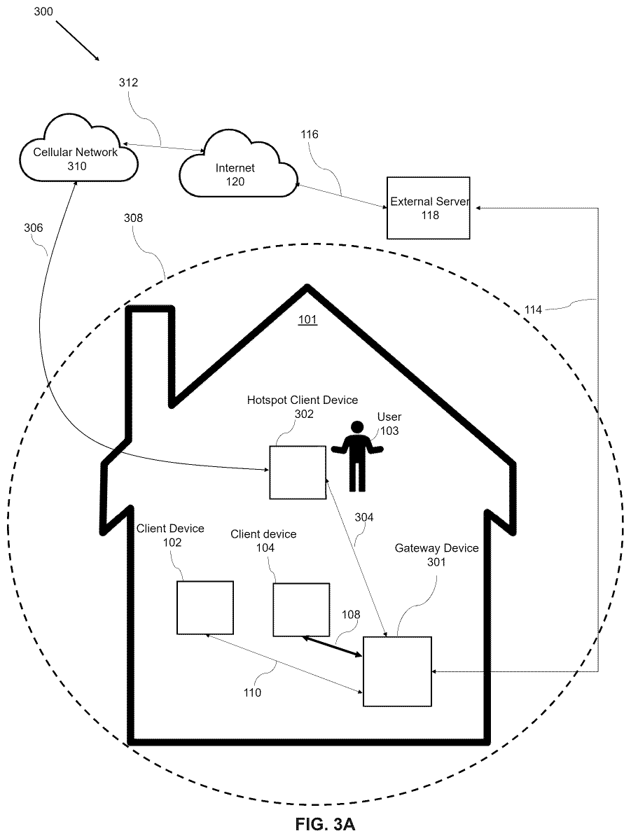

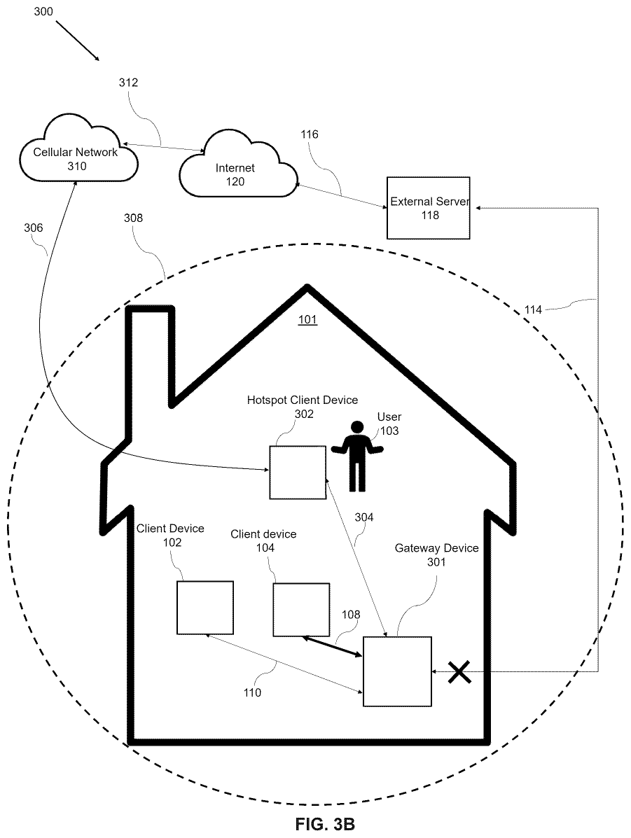

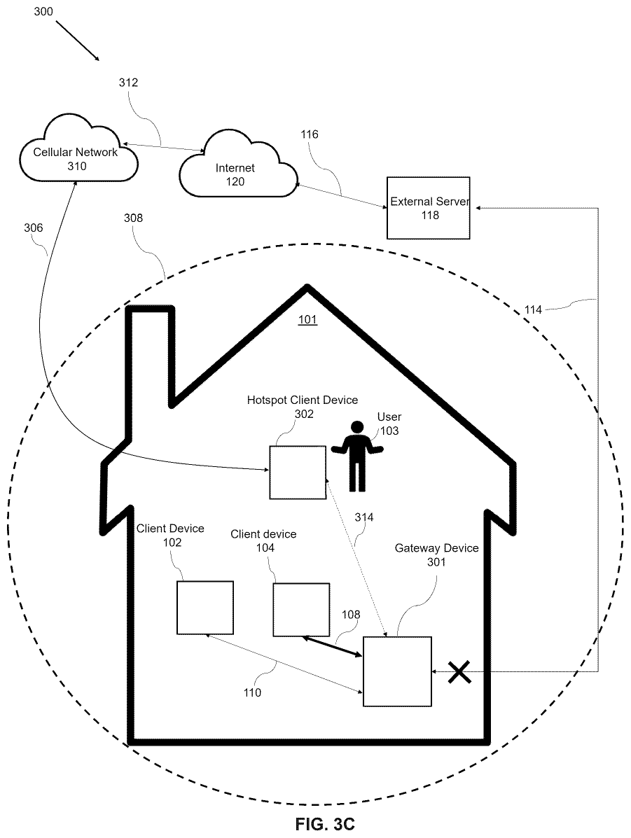

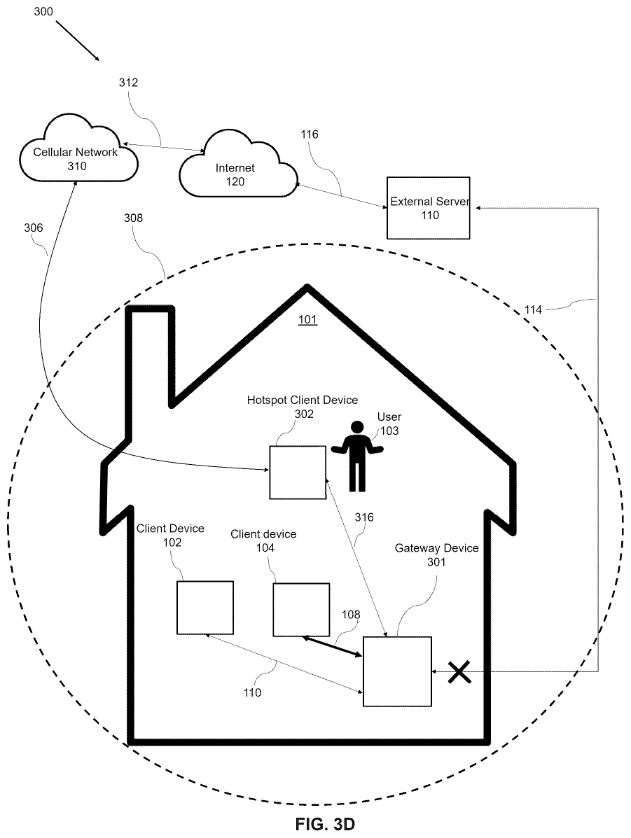

As shown in FIG. 2A, the user connects their HCD to the Wi-Fi network (S214). This will be described in greater detail with reference to FIG. 3A.

FIG. 3A illustrates a communication system 300 at a time to in accordance with aspects of the present disclosure.

As shown in FIG. 3A, communication system 300 includes: residence 101; client devices 102, 104, and 302; user 103; a GD 301; wired communication channel 108; wireless communication channel 110, WAN communication link 114, communication link 116, a communication channel 304, a communication channel 312; a local area network (LAN) 308; a cellular communication channel 306; external server 118; Internet 120; and a cellular network 310.

GD 301 is a device that combines the functions of a modem and a router. A modem is a device that connects to cable or phone lines and translates the data or information from the Internet to a computer or connected device. A router is a device that works with the modem to create and manage a wireless network so as to wirelessly take the data coming through the modem and sends it wirelessly to multiple devices like smart phones, tablets, gaming consoles, and computers. The consumer premises can include a residential dwelling, an office, or any other business space of a user, such as residence 101. The terms home, office, and premises may be used synonymously herein.

GD 301 may perform such functions as Web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Further, it should be noted that GD 301, in a primary mode of operation, is able to communicate with external server 118 via WAN communication link 114, which may optionally be a wireless communication system, such as 4G, or 5G, and further is able to connect to Internet 120 via communication link 116. Further, as will be described in greater detail below, GD 301, in a hotspot mode of operation, is additionally able to communicate with external server 118, when WAN communication link 114 is down, alternatively via HCD 302, cellular communication channel 306, cellular network 310, wireless communication channel 312, Internet 120 and communication link 116 in accordance with aspects of the present disclosure.

GD 301 serves as a gateway or access point to Internet 120 for one or more electronic devices.

HCD 302 is connected to GD 301 wirelessly via wireless communication channel 304.

Further, HCD 302 is able to connect to Internet 120 through cellular communication channel 306, cellular network 310, and wireless communication channel 312. However, HCD 302 will access Internet 120 through GD 301 during primary mode of operation.

LAN 308 is created and managed through GD 301. LAN 308 is illustrated as a single network, merely for purposes of discussion. It should be noted that LAN 308 may represent a plurality of local area networks created and managed through GD 301. LAN 308 is a communication network where client device 102 can wirelessly communicate with GD 301 in order to access Internet 120 through WAN communication link 114, external server 118, and communication link 116. Client device 104 is connected to LAN 308 through wired communication channel 108. As such, for purposes of this discussion, LAN 308 includes a wireless network for client device 102 to wirelessly communicate with GD 301 and a wired network, e.g., an Ethernet interface, for client device 104 to communicate with GD 301.

It should be noted that LAN 308 is illustrated and discussed to include a single wireless network and a single wired network. However, in accordance with aspects of the present disclosure, GD 301 may create and manage a plurality of distinct local area networks. As such, LAN 308 is representative of a summation of local area networks created and managed by GD 301. Further, GD 301 is configured to act as a bridge for communications from the summation of local area networks to the Internet.

In operation, client device 102 and HCD 302 may onboard onto LAN 308 through known wireless protocols, a non-limiting example of which includes Wi-Fi network protocols. Similarly, client device 104 may connect to LAN 308 by known protocols, a non-limiting example of which includes ethernet protocols. Therefore, in this example, LAN 308 includes client devices 102 and 104, HCD 302, and GD 301.

For example, returning to FIG. 2A, user 103 will operate HCD 302 and connect it with GD 301, shown as wireless communication channel 304.

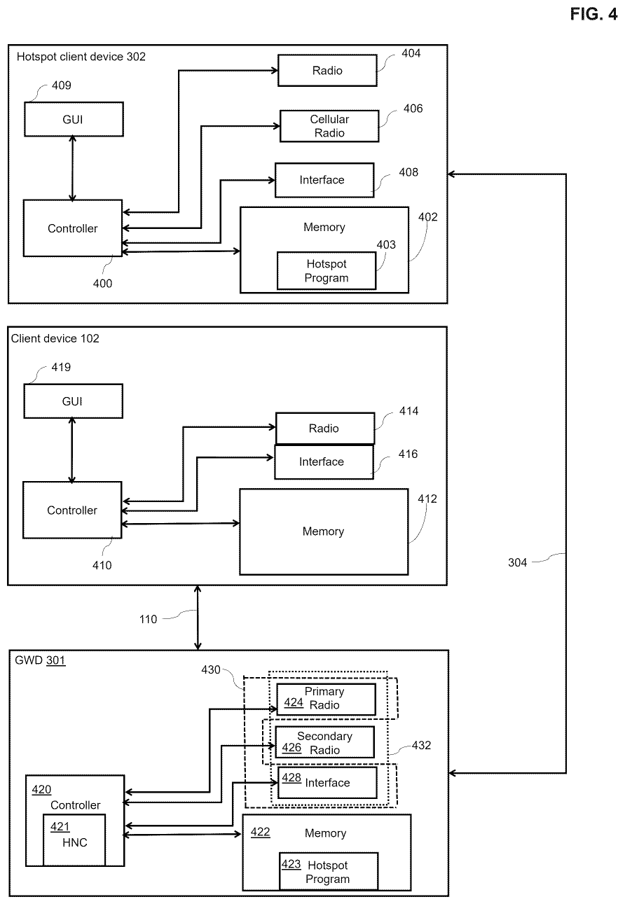

As shown in FIG. 2A, the user downloads instructions for the HCD (S216). This will be described in greater detail with reference to FIG. 4.

FIG. 4 illustrates an exploded view of HCD 302, client device 102, and GD 301.

As shown in FIG. 4, HCD 302 includes a controller 400; a memory 402, which has stored therein a hotspot program 403; at least one radio, a sample of which is illustrated as a radio 404 and a cellular radio 406; an interface 408; and a graphic user interface (GUI) 409.

In this example, controller 400, memory 402, radio 404, cellular radio 406, and interface 408 are illustrated as individual devices. However, in some embodiments, at least two of controller 400, memory 402, radio 404, cellular radio 406, and interface 408 may be combined as a unitary device. Further, in some embodiments, at least one of controller 400 and memory 402 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc.

Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types.

Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 400 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of HCD 302 in accordance with the embodiments described in the present disclosure.

Memory 402, as will be described in greater detail below, has instructions, including hotspot program 403, stored therein to be executed by controller 400 to allow HCD 302 to: transmit the hotspot ID and hotspot credentials to GD 301; establish a hotspot connection with GD 301; route client device data between client devices 102 and 104 and Internet 120 via cellular network 310 during a hotspot mode of operation; and disable the hotspot mode of operation and reconnect to GD 301 as a client device.

Radio 404 may include a Wi-Fi WLAN interface radio transceiver that is operable to communicate with GD 301, as shown in FIG. 3A, and also may include a cellular transceiver operable to communicate with a cellular network. Radio 404 and cellular radio 406 include one or more antennas and communicate wirelessly via one or more of the 2.4 GHz band, the 5 GHZ band, the 6 GHz band, and the 60 GHz band, or at the appropriate band and bandwidth to implement any IEEE 802.11 Wi-Fi protocols, such as the Wi-Fi 4, 5, 6, or 6E protocols. HCD 302 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF 4CE protocol, ZigBee protocol, Z-Wave protocol, or IEEE 802.15.4 protocol.

Radio 404 is configured to allow HCD 302 to communicate with GD 301 in a primary mode of operation and a hotspot mode of operation.

Cellular radio 406 is configured to communicate with cellular network 310 when GD 301 no longer has connection to Internet 120, due to the disconnection of wireless WAN communication link 114.

As shown in FIG. 3A, cellular radio 406 is configured to enable HCD 302 to wirelessly communicate with cellular network 310 over cellular communication channel 306, by known cellular protocols.

Returning to FIG. 4, interface 408 can include one or more connectors, such as RF connectors, or Ethernet connectors, and/or wireless communication circuitry, such as 5G circuitry and one or more antennas.

GUI 409 may be any known device or system to display an interactive image to enable a user to interact with HCD 302.

Client device 102 includes a controller 410; a memory 412; at least one radio, a sample of which is illustrated as a primary radio 414 and a secondary radio 414; an interface 416; and a GUI 419.

In this example, controller 410, memory 412, primary radio 414, secondary radio 414, and interface 416 are illustrated as individual devices. However, in some embodiments, at least two of controller 410, memory 412, primary radio 414, secondary radio 414, and interface 416 may be combined as a unitary device. Further, in some embodiments, at least one of controller 410 and memory 412 may be implemented as a computer having tangible computer-readable media for carrying or having computer-executable instructions or data structures stored thereon.

Controller 410 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of extender 302 in accordance with the embodiments described in the present disclosure.

Memory 412 can store various programming, user content, and data.

Radio 414 may include a Wi-Fi WLAN interface radio transceiver that is operable to communicate with GD 301. Radio 414 includes one or more antennas and communicate wirelessly via one or more of the 2.4 GHz band, the 5 GHz band, the 6 GHz band, and the 6E GHz band, or at the appropriate band and bandwidth to implement any IEEE 802.11 Wi-Fi protocols, such as the Wi-Fi 4, 5, 6, or 6E protocols. Radio 414 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHZ bands, 5 GHz bands, 6 GHz bands or 6E GHz bands, RF 4CE protocol, ZigBee protocol, Z-Wave protocol, or IEEE 802.15.4 protocol.

Interface 416 can include one or more connectors, such as RF connectors, or Ethernet connectors, and/or wireless communication circuitry, such as 5G circuitry and one or more antennas.

GUI 419 may be any known device or system to display an interactive image to enable a user to interact with client device 102.

GD 301 includes a controller 420, which has stored therein a home network controller (HNC) 421; a memory 422, which has stored therein a hotspot program 423; and at least one radio, a sample of which is illustrated as a primary radio 424 and a secondary radio 426; and an interface 428. Primary radio 424 and interface 428 together are considered a primary communication system 430, whereas primary radio 424, secondary radio 426, and interface 428 are considered a secondary communication system 432.

Primary communication system 430 is configured to enable GD 301 to operate in the primary mode of operation, wherein GD 301 is able to communicate with HCD 302, client device 102, and client device 104 in the primary mode of operation, wherein GD 301 is able to communicate with Internet 120 via WAN communication link 114 (and external server 118 and communication link 116). In particular, in the primary mode of operation, primary radio 424 enables GD 301 to wirelessly communicate with client device 102 and HCD 302, whereas interface 428 enables GD 301 to communicate with client device 104.

Secondary communication system 432 is configured to enable GD 301 to operate in the hotspot mode of operation, wherein GD 301 is able to communicate with client device 102, and client device 104 in the hotspot mode of operation, wherein GD 301 is able to communicate with Internet 120 via HCD 302 (and cellular communication channel 306, cellular network 310, and wireless communication channel 312). In particular, in the hotspot mode of operation, primary radio 424 enables GD 301 to wirelessly communicate with client device 102 and interface 428 enables GD 301 to communicate with client device 104. However, as opposed to the primary mode of operation, in the hotspot mode of operation, secondary radio 426 enables GD 301 to wirelessly communicate with HCD 302 over a dedicated channel so as to route data from client device 102 and client device 104 to Internet 120 via cellular communication channel 306, cellular network 310 and wireless communication channel 312.

In this example, controller 420, memory 422, primary radio 424, secondary radio 426 and interface 428 are illustrated as individual devices. However, in some embodiments, at least two of controller 420, memory 422, primary radio 424, secondary radio 426, and interface 428 may be combined as a unitary device. Further, in some embodiments, at least one of controller 420 and memory 422 may be implemented as a computer having tangible computer-readable media for carrying or having computer-executable instructions or data structures stored thereon.

Controller 420 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of GD 301 in accordance with the embodiments described in the present disclosure.

HNC 421 controls GD 301 within LAN 308. HNC 421 may perform tasks such as steering connected devices, a non-limiting example of which is a cell phone, from one access point to another.

Memory 422, as will be described in greater detail below, has instructions, including hotspot program 423, stored therein to be executed by controller 420 to allow GD 301 to: receive the hotspot ID and hotspot credentials from HCD 302; instruct primary communication system 430 to route the client device data between client devices 102 and 104 and Internet 120 and to route the wireless device data between HCD 302 and Internet 120; detect a loss of connection with Internet 120; and instruct secondary communication system 432 to route the client device data between client devices 102 and 104 and Internet 120 via HCD and cellular network 310.

In some embodiments, hotspot program 423, as will be described in greater detail below, has instructions stored therein to be executed by controller 420 to allow GD 301 to establish constraints in the hotspot mode.

In some embodiments, hotspot program 423, as will be described in greater detail below, has instructions, stored therein to be executed by controller 420 to allow GD 301 to request the hotspot ID and hotspot credentials from HCD 302.

Primary radio 424 and secondary radio 426, may include a Wi-Fi WLAN interface radio transceiver that is operable to communicate with client device 102, hot spot client device 302 and external server 110. Primary radio 424 and secondary radio 426 includes one or more antennas and communicates wirelessly via one or more of the 2.4 GHz band, the 5 GHz band, the 6 GHz band, and the 6E GHz band, or at the appropriate band and bandwidth to implement any IEEE 802.11 Wi-Fi protocols, such as the Wi-Fi 4, 5, 6, or 6E protocols. Primary radio 424 and secondary radio 426 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHZ bands or 6E GHZ bands, RF 4CE protocol, ZigBee protocol, Z-Wave protocol, or IEEE 802.15.4 protocol.

Primary radio 424 is configured to communicate with client device 102. More specifically, primary radio 424 is configured to communicate with client device 102 and HCD 302, while GD 301 remains connected to Internet 120. Further, primary radio 424 is configured to communicate with client device 102 in those instances when GD 301 is disconnected from Internet 120. Secondary radio 426 is configured to communicate with HCD 302 when GD 301 is disconnected from Internet 120.

Interface 428 can include one or more connectors, such as RF connectors, or Ethernet connectors, and/or wireless communication circuitry, such as 5G circuitry and one or more antennas. Interface 428 receives data from external server 118 by known methods, non-limiting examples of which include terrestrial antenna, satellite dish, wired cable, DSL, optical fibers, or 5G as discussed above. Interface 428 is additionally configured to communicate with client device 104.

During a primary mode of operation, GD 301 is configured to route the data of client devices 102 and 104 between Internet 120. Further, during the primary mode of operation, GD 301 is configured to route the data of HCD 302 to Internet 120.

During a hotspot mode of operation, GD 301 is configured to route the data of client devices 102 and 104 to HCD 302, so as to then be routed to Internet 120 via cellular network 310.

For example, with reference to FIG. 4, user 103 will operate HCD 302, and download hotspot program 403.

As shown in FIG. 2A, the HCD establishes a Wi-Fi connection on the GD FH SSID (S218). This is shown as wireless communication channel 304 in FIG. 3A, connecting HCD 302 to GD 301.

As shown in FIG. 2A, the user follows the instructions giving permission for hotspot creation for the GD WAN backup service (S220). For example, as shown in FIG. 4, hotspot program 403 has instructions stored therein to cause HCD 302 to begin acting as a hotspot when GD 301 detects a connection loss to Internet 120.

In some embodiments, user 103 may alter or constrain the hotspot mode of operation, non-limiting examples of alterations or constraints including a hotspot time limit or a traffic rate limit. For example, using GUI 409, user 103 may establish which clients devices may use the HCD 302 as a hotspot, e.g., family smartphones, and may establish which client devices may not use the HCD 302 as a hotspot, e.g, a gaming system. In another example, using GUI 409, user 103 may establish which applications may use the HCD 302 as a hotspot, e.g., cellular communications or Internet browsing, and may establish which applications may not use the HCD 302 as a hotspot, e.g, video streaming services.

As shown in FIG. 2A, the HCD fBSS traffic is transmitted to the GD using the FH SSID (S222). For example, as shown in FIG. 4, HCD 302 will communicate with GD 301 through communication channel 304 as a normal client device.

As shown in FIG. 2A, the HCD indicates its Wi-Fi hotspot SSID and credentials for use when the GD signals its primary WAN connection loss (S224). The GD then acknowledges the SSID and credentials (S226). For example, as shown in FIG. 4, HCD 302 transmits, via radio 404, the SSID and credentials to radio 424 of HCD 302 so that GD 301 may connect to HCD 302 as a client in the case of the primary WAN connection loss. GD 301 will transmit and acknowledgement, via radio 424, back to radio 404 of HCD 302.

As shown in FIG. 2A, the GD detects a primary WAN connection loss (S228). This will be described in greater detail with reference to FIG. 3B.

FIG. 3B illustrates a communication system 300 at a time t₁ in accordance with aspects of the present disclosure.

As shown in FIG. 3B, wireless communication system 114 is crossed out, indicating that GD 301 no longer has access to Internet 120 through wireless WAN communication link 114.

For example, returning to FIG. 2A, presume that due to unforeseen circumstances, wireless WAN communication link 114 is no longer working. GD 301 no longer has access to Internet 120. Thus, client device 102, client device 104, and HCD 302 also do not have access to Internet 120 through GD 301.

Returning to FIG. 2A, the GD requests the HCD to enable its Wi-Fi hotspot (S230), and HCD acknowledges the request (S232). For example, as shown in FIG. 4, controller 420 will execute instructions within hotspot program 423 to cause GD 301 to transmit, via radio 424, a hotspot request to HCD 302. Controller 400 will execute instructions stored within hotspot program 403 to cause HCD 302 to receive the hotspot request from GD 301 via radio 404 and transmit an acknowledgement signal back to GD 301.

GD 301 requires an acknowledgement from HCD 302 in order to proceed with the hotspot mode of operation.

Returning to FIG. 2A, the HCD disables the fBSS connection to the GD and starts the hotspot for GD fBSS access (S234). This will be described in greater detail with reference to FIG. 3C.

FIG. 3C illustrates a communication system 300 at a time t₂ in accordance with aspects of the present disclosure.

As shown in FIG. 3C, WAN communication link 114 is crossed out, indicating that GD 301 still does not have access to Internet 120 through WAN communication link 114. Further, wireless communication channel 304 has been replaced with wireless communication channel initiation 314. As shown in FIG. 4, controller 400 executes instructions stored on memory 402 causing HCD 302 to disconnect from GD 301 and transmit wireless communication channel initiation 314 to GD 301.

Returning to FIG. 2A, the HCD is disabled as a fBSS (S236).

As shown in FIG. 2A, the bBSS configured with the HCD hotspot credentials is enabled (S238), and the HCD hotspot is enabled with the needed credentials (S240). For example, as shown in FIG. 4, controller 420 will execute instructions within hotspot program 423 to prepare GD 301 to establish a backhaul connection to HCD 301 as a hotspot client. Controller 400 will execute instructions within hotspot program 403 to prepare HCD 301 to act as a hotspot for GD 301.

In order for GD 301 to connect to HCD 302 in the hotspot mode of operation, HCD 302 must transmit connection credentials to GD 301, non-limiting examples of connection credentials including a hotspot SSID and hotspot password. To prevent outside other users in the residential area from connecting to HCD 301 during hotspot mode of operation, only GD 301 will have access to the needed connection credentials.

As shown in FIG. 2A, the GD bBSS is enabled (S242) and the HCD hotspot is enabled (S244).

The timer for the GD WAN backup service is started (S246). As shown in FIG. 4, controller 400 will execute instructions within hotspot program 403 causing HCD 302 to start a timer. A non-limiting example of a timer length may be 10 minutes. If GD 301 does not reestablish the primary WAN connection before the example timer length of 10 minutes, HCD will automatically disable the hotspot mode of operation.

In some embodiments, a user may establish the time of the timer via GUI 409. In this manner, a user of HCD 302 may be in control of the amount of data usage of HCD 302 in the event that HCD 302 is needed as a hotspot.

As shown in FIG. 2A, the GD establishes a Wi-Fi connection with the HCD hotspot (S248). This will be described in greater detail with reference to FIG. 3D.

FIG. 3D illustrates a communication system 300 at a time t₃ in accordance with aspects of the present disclosure.

As shown in FIG. 3D, wireless communication system 114 is crossed out, indicating that GD 301 still does not have access to Internet 120 through wireless WAN communication link 114. Further, wireless communication channel 304 has been replaced with wireless communication channel 316. Wireless communication channel 316 represents the new connection between HCD 302 and GD 301, wherein HCD 302 acts as a hotspot and GD 301 is connected to HCD 302 as a client.

For example, with reference to FIG. 2A, GD 301 will connect to HCD 302 as a client, shown through wireless communication channel 316. Now, client device 102 and client device 104 are able to access Internet 120 through GD 301, wireless communication channel 316, HCD 302, cellular communication channel 306, cellular network 310, and wireless communication channel 312.

Returning to FIG. 2A, the GD traffic is transmitted to the HCD using the hotspot (S250). For example, as shown in FIG. 4, client device traffic from client device 102 is received by primary radio 424 at GD 301, which is then routed to radio 404 of HCD 302 via secondary radio 426. Controller 400 executes instructions in hotspot program 403 to instruct cellular radio 406 to route the client device traffic to Internet 120 via cellular network 310, as shown in FIG. 3C.

Similarly, any downstream client device traffic originating from Internet 120 and passing through cellular network 310 will be received by cellular radio 406 of HCD 302. Controller 400 will execute instructions within hotspot program 403 to instruct radio 404 to route this downstream client device traffic to secondary radio 426 of GD 301. Controller 420 will execute instructions within hotspot program 423 to cause primary radio 424 to route the received downstream client device traffic to radio 414 of client device 102.

Returning to FIG. 2A, after the GD traffic is transmitted to the HCD using the hotspot (S250), the GD detects the reestablished primary WAN connection (S252). For example, as shown in FIG. 4, controller 420 will execute instructions within hotspot program 423 to cause GD 301 to monitor the connection status of wireless WAN communication link 114. After some period of time, GD 301 will detect that wireless WAN communication link 114 is active again.

As shown in FIG. 2A, after the GD detects the reestablished primary WAN connection (S252), the GD disables the bBSS connection to the HCD hotspot (S254). For example, once GD 301 detects that wireless WAN communication link 114 is active again, controller 420 will execute instructions within hotspot program 423 to cause GD 301 to disable the backhaul connection with HCD 302, disconnecting from the hotspot.

Further, it should be noted that in some embodiments, the GD 301 will issue a message to the HCD 302 for HCD 212 to disable its hot spot service, prior to disabling its GD bSTA 206 connection to the HCD Hotspot 210. This may be very useful in the situation wherein many houses in a neighborhood or apartment building all lose WAN service. In such a case, HCD 302 might pop up to all the neighbors as a viable hotspot for connection to the WAN. Further, the user of HCD 302 might not even know that this is happening. Accordingly, to prevent such a situation, GD 301 may instruct HCD 302 to disable its normal hotspot SSID.

FIG. 2A ends at step A (S256). Ladder chart 200 continues into FIG. 2B.

FIG. 2B illustrates ladder chart 200 for connecting to a WAN through a hotspot from step A (S256) in accordance with aspects of the present disclosure.

As shown in FIG. 2B, the GD bBSS configured with the HCD credentials is disabled (S258).

As shown in FIG. 2B, the GD bBSS connection with the HCD is lost (S260). GD 301 disconnects from HCD 302. With WAN communication link 114 active, GD 302 is once again the main access point to Internet 120.

As shown in FIG. 2B, after the GD bBSS connection with the HCD is lost (S260), the HCD disables the hotspot and reenables HCD fBSS connection to the GD (S262). For example, with GD 301 disconnected from HCD 302, controller 400 will execute instructions within hotspot program 403 causing HCD 302 to disable the hotspot mode of operation and to begin acting as a client device once again.

As shown in FIG. 2B, the HCD hotspot is disabled and the HCD fBSS is enabled (S264).

As shown in FIG. 2B, after the HCD hotspot is disabled and the HCD fBSS is enabled (S264), the timer for the GD WAN backup service is disabled (S266). As shown in FIG. 4, after GD 301 has disconnected from HCD 302 as a client, controller 400 will execute instructions within hotspot program 403 causing HCD 302 to disable timer.

As shown in FIG. 2B, after the HCD hotspot is disabled and the HCD fBSS is enabled (S266), the HCD fBSS reestablishes Wi-Fi connection with the GD FH SSID (S268). For example, with reference to FIG. 3A, HCD 302 reconnects to GD 301 through communication channel 304. With WAN communication link 114 active once more, client device 102, client device 104, and HCD 302 all have access to Internet 120 through GD 301, wireless WAN communication link 114, external server 118, and wireless communication link 116.

As shown in FIG. 2B, after the HCD fBSS reestablishes Wi-Fi connection with the GD FH SSID (S268), the HCD fBSS traffic is transmitted to the GD using the FH SSID (S270).

In some embodiments, the hotspot mode of operation timer will not time out before the GD detects the reestablishment of the primary WAN connection. This will be described in greater detail below.

If the timer expired for GD WAN backup service, disable hotspot and reenable HCD fBSS (S272). For example, presume that the user started a timer for the hotspot mode of operation to last 10 minutes. If, after 10 minutes, GD 301 has not detected the reestablishment of wireless WAN communication link 114, then controller 400 will execute instructions within hotspot program 403 causing HCD 302 to automatically disable the hotspot mode of operation.

HCD 302 will then begin operating as a client device to reconnect to GD 301 once GD 301 has reconnected to Internet 120.

As shown in FIG. 2B, the HCD hotspot is disabled and the HCD fBSS is enabled (S274).

After the HCD hotspot is disabled and the HCD fBSS is enabled (S274), the HCD fBSS reestablishes Wi-Fi connection with the GD FH SSID (S276). For example, as the hotspot mode of operation timer timed out, GD 301 has still not reconnected to Internet 120. With reference to FIG. 3B, HCD 302 is the only device to have access to Internet 120 cellularly. Client device 102, client device 104, and GD 301 will all be without access to Internet 120 until user 103 restarts the hotspot mode of operation, or GD 301 reestablishes connection to Internet 120 through wireless WAN communication link 114, external server 118, and wireless communication link 116. For purposes of the discussion, presume that GD 301 is able to reestablish connection to Internet 120 shortly after the hotspot mode of operation timer times out. HCD 302 reconnects to GD 301 through communication channel 304. With WAN communication link 114 active once more, client device 102, client device 104, and HCD 302 all have access to Internet 120 through GD 301, wireless WAN communication link 114, external server 118, and wireless communication link 116.

As shown in FIG. 2B, after the HCD fBSS reestablishes Wi-Fi connection with the GD FH SSID (S276), the HCD fBSS traffic is transmitted to the GD using the FH SSID (S278).

As shown in FIG. 2B, after the HCD fBSS traffic is transmitted to the GD using the FH SSID (S278), ladder chart 200 ends (S280).

In some embodiments, a timer might not be started. For example, presume that HCD 302 has begun operating in hotspot mode. HCD 302 will not deactivate the hotspot and return to the primary mode of operation until GD 301 reestablishes connection to Internet 120 via wireless WAN communication link 114, external server 118, and wireless communication link 116.

In instances where the GD is disconnected from the WAN, it can be inconvenient to users operating network devices. While these instances may be few and far between, some will be more inconvenient than others due to the length of time that the GD is disconnected from the Internet. There needs to be a way for users to minimize time without Internet access while the GD attempts to reconnect to the network.

In accordance with the present disclosure, a GD is used with an HCD. The HCD will transmit hotspot credentials to the GD, allowing the GD to connect to the HCD while it is operating in hotspot mode of operation. When the GD is disconnected from the WAN, the HCD will begin acting as a hotspot. The GD will connect, allowing the GD to access the WAN.

Further, all devices connected to the GD will have access to the WAN. Once the GD reestablishes its primary connection with the WAN, the HCD will stop acting as a hotspot and reconnect to the GD as a client.

Thus, the present disclosure as disclosed minimizes downtime due to WAN disconnection by reconnecting to the WAN through the use of a hotspot.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A gateway device for use with a wide area network, wireless wide area network, a local area network, a client device and a wireless device, the client device being configured to transmit client device data to the wide area network via the local area network and said gateway device, the wireless device being configured to operate in a first mode so as to wirelessly transmit wireless device data to the wide area network via the local area network and said gateway device, being configured to operate in a hotspot mode so as to wirelessly transmit the wireless device data and the client device data to the wide area network via the wireless wide area network, and being configured to transmit a hotspot ID and hotspot credentials to said gateway device, said gateway device comprising:
a memory;
a primary communication system configured to route the client device data between the client device and the wide area network and to route the wireless device data between the wireless device and the wide area network;
a wireless communication system configured to route the client device data between the client device and the wide area network via the wireless device and the wireless wide area network; and
a processor configured to execute instructions stored on said memory to cause said gateway device to:
receive the hotspot ID and hotspot credentials from the wireless device;
instruct said primary communication system to route the client device data between the client device and the wide area network and to route the wireless device data between the wireless device and the wide area network;
detect a loss of connection with the wide area network; and
instruct said wireless communication system to route the client device data between the client device and the wide area network via the wireless device and the wireless wide area network.

2. The gateway device of claim 1, wherein said processor is configured to execute instructions stored on said memory to additionally cause said gateway device to establish constraints in the hotspot mode.

3. The gateway device of claim 2, wherein the constraints are selected from a group of constraints consisting of a time limit of the hotspot mode, a traffic rate limit in the hotspot mode, a data type in the hotspot mode, and combinations thereof.

4. The gateway device of claim 3, wherein said primary communication system is configured to route the client device data between the client device and the wide area network via an interface system selected from a group of interface systems consisting of a data over a cable service interface specification system, a passive optical network system, an ethernet system, and a digital subscriber line system.

5. The gateway device of claim 1, wherein said processor is configured to execute instructions stored on said memory to additionally cause said gateway device to request the hotspot ID and hotspot credentials from the wireless device.

6. The gateway device of claim 1, wherein said primary communication system comprises a wireless communication system.

7. A method of using a gateway device with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device, being configured to operate in a hotspot mode so as to wirelessly transmit the wireless device data and the client device data to the wide area network via the wireless wide area network, and being configured to transmit a hotspot ID and hotspot credentials to the gateway device, said method comprising:
receiving, via a processor configured to execute instructions stored on a memory, the hotspot ID and hotspot credentials from the wireless device;
instructing, via the processor, a primary communication system to route the client device data between the client device and the wide area network and to route the wireless device data between the wireless device and the wide area network;
detecting, via the processor, a loss of connection with the wide area network; and
instructing, via the processor, a wireless communication system to route the client device data between the client device and the wide area network via the wireless device and the wireless wide area network.

8. The method of claim 7, wherein said instructing, via the processor, the wireless communication system to route the client device data between the client device and the wide area network via the wireless device and the wireless wide area network comprises establishing constraints in the hotspot mode.

9. The method of claim 8, wherein said establishing constraints in the hotspot mode comprises establishing the constraints as selected from a group of constraints consisting of a time limit of the hotspot mode, a traffic rate limit in the hotspot mode, a data type in the hotspot mode, and combinations thereof.

10. The method of claim 9, wherein said instructing, via the processor configured to execute instructions stored on a memory, the primary communication system to route the client device data between the client device and the wide area network and to route the wireless device data between the wireless device and the wide area network comprises instructing the primary communication system to route the client device data between the client device and the wide area network and to route the wireless device data between the wireless device and the wide area network via an interface system selected from a group of interface systems consisting of a data over a cable service interface specification system, a passive optical network system, an ethernet system, and a digital subscriber line system.

11. The method of claim 7, further comprising instructing, via the processor, a primary communication system to request the hotspot ID and hotspot credentials from the wireless device.

12. The method of claim 7, wherein said instructing, via the processor configured to execute instructions stored on a memory, the primary communication system to route the client device data between the client device and the wide area network and to route the wireless device data between the wireless device and the wide area network additionally comprises instructing a wireless communication system to route the client device data between the client device and the wide area network and to route the wireless device data between the wireless device and the wide area network.

13. A non-transitory, computer-readable media having computer-readable instructions stored thereon, the computer-readable instructions being capable of being read by a gateway device for use with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device, being configured to operate in a hotspot mode so as to wirelessly transmit the wireless device data and the client device data to the wide area network via the wireless wide area network, and being configured to transmit a hotspot ID and hotspot credentials to the gateway device, wherein the computer-readable instructions are capable of instructing the client device to perform the method comprising:
receiving, via a processor configured to execute instructions stored on a memory, the hotspot ID and hotspot credentials from the wireless device;
instructing, via the processor, a primary communication system to route the client device data between the client device and the wide area network and to route the wireless device data between the wireless device and the wide area network;
detecting, via the processor, a loss of connection with the wide area network; and
instructing, via the processor, a wireless communication system to route the client device data between the client device and the wide area network via the wireless device and the wireless wide area network.

14. The non-transitory, computer-readable media of claim 13, wherein the computer-readable instructions are capable of instructing the client device to perform the method wherein said instructing, via the processor, the wireless communication system to route the client device data between the client device and the wide area network via the wireless device and the wireless wide area network comprises establishing constraints in the hotspot mode.

15. The non-transitory, computer-readable media of claim 14, wherein the computer-readable instructions are capable of instructing the client device to perform the method wherein said establishing constraints in the hotspot mode comprises establishing the constraints as selected from a group of constraints consisting of a time limit of the hotspot mode, a traffic rate limit in the hotspot mode, a data type in the hotspot mode, and combinations thereof.

16. The non-transitory, computer-readable media of claim 15, wherein the computer-readable instructions are capable of instructing the client device to perform the method wherein said instructing, via the processor configured to execute instructions stored on a memory, the primary communication system to route the client device data between the client device and the wide area network and to route the wireless device data between the wireless device and the wide area network comprises instructing the primary communication system to route the client device data between the client device and the wide area network and to route the wireless device data between the wireless device and the wide area network via an interface system selected from a group of interface systems consisting of a data over a cable service interface specification system, a passive optical network system, an ethernet system, and a digital subscriber line system.

17. The non-transitory, computer-readable media of claim 15, wherein the computer-readable instructions are capable of instructing the client device to perform the method further comprising instructing, via the processor, a primary communication system to request the hotspot ID and hotspot credentials from the wireless device.

18. The non-transitory, computer-readable media of claim 13, wherein the computer-readable instructions are capable of instructing the client device to perform the method wherein said instructing, via the processor configured to execute instructions stored on a memory, the primary communication system to route the client device data between the client device and the wide area network and to route the wireless device data between the wireless device and the wide area network additionally comprises instructing a wireless communication system to route the client device data between the client device and the wide area network and to route the wireless device data between the wireless device and the wide area network.
